(19) United States
(12) Patent Application Publication
(10) Pub. No.: US 2008/0067169 A1
(43) Pub. Date: Mar. 20, 2008

(54) Insulated packages for microwaveable foods

(76) Inventors: Terrence P. Lafferty, Winneconne, WI (US); Scott W. Middleton, Oshkosh, WI (US); Timothy Henry Bohrer, Chicago, IL (US); Colin P. Ford, Woodstock, GA (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/903,260

(22) Filed: Sep. 21, 2007

Related U.S. Application Data
(62) Division of application No. 11/221,159, filed on Sep. 7, 2005.
(60) Provisional application No. 60/626,659, filed on Nov. 10, 2004.
(60) Provisional application No. 60/628,703, filed on Nov. 17, 2004.

(51) Int. Cl. H05B 6/80

(52) U.S. Cl. 219/730

(57) ABSTRACT

Various packages for heating a food item therein are disclosed.

### CROSS-REFERENCE TO RELATED APPLICATIONS

This application is a divisional of co-pending U.S. application Ser. No. 11/221,159, filed Sep. 7, 2005, which claims the benefit of U.S. Provisional Application No. 60/626,659, filed Nov. 10, 2004, and U.S. Provisional Application No. 60/628,703, filed Nov. 17, 2004, each of which is incorporated by reference in its entirety.

### BACKGROUND

Microwave ovens have become a principle form of cooking food in a rapid and effective manner. As a result, the number of food items and packages available for use with a microwave oven is increasing. There is always a need for improved materials, blanks, and packages.

### SUMMARY

Various packages for heating a food item in a microwave oven are disclosed. In one aspect, a package according to the present invention includes a susceptor, a thermal insulating material, and an optional support. Other aspects, features, and advantages of the present invention will become apparent from the following description and accompanying figures.

### BRIEF DESCRIPTION OF THE DRAWINGS

The description refers to the accompanying drawings in which like reference characters refer to like parts throughout the several views, and in which:

FIG. 1 depicts an exemplary package including a susceptor sleeve and a thermal insulating shell in accordance with the present invention;

FIG. 2 depicts the package of FIG. 1 in an upright position with a food item contained therein;

FIG. 3 depicts an exemplary blank for preparing the package of FIGS. 1 and 2;

FIG. 4 depicts the package of FIGS. 1 and 2 in a partially opened condition;

FIG. 5 depicts an exemplary package including a susceptor sleeve and a thermal insulating shell formed from a corrugated material in accordance with the present invention;

FIG. 6 depicts an exemplary package including a susceptor sleeve and a thermal insulating sheath in accordance with the present invention;

FIG. 7 depicts an exemplary package including a semi-rigid susceptor sleeve and a thermal insulating material applied thereto in accordance with the present invention;

FIG. 8 depicts an exemplary blank for forming the package of FIG. 7;

FIG. 9 depicts the package of FIG. 7 with a closed bottom panel;

FIG. 10 depicts an alternate view of the package of FIG. 9;

FIG. 11 depicts an exemplary blank that may be used to form a package having two locking ends according to the present invention;

FIG. 12 depicts an exemplary package having a double flap construction at one end in accordance with the present invention;

FIG. 13 depicts an exemplary package including a susceptor sleeve formed from a thermal insulating corrugated material in accordance with the present invention;

FIG. 14 depicts an exemplary package including a susceptor sleeve formed from a thermal insulating bubble material in accordance with the present invention;

FIG. 15 depicts the various layers of an exemplary susceptor used in the exemplary package of FIG. 14;

FIG. 16 depicts an exemplary package including a susceptor sleeve formed from a thermal insulating foam in accordance with the present invention;

FIG. 17 depicts the various layers of an exemplary susceptor used in the exemplary package of FIG. 16;

FIG. 18 depicts an exemplary package including a susceptor sleeve formed from a thermal insulating bubble material, and without a paper layer, in accordance with the present invention;

FIG. 19 depicts an exemplary package including a sleeve formed from multiple layers of nylon film and nylon strips in accordance with the present invention;

FIG. 20 depicts a food item cooked in the exemplary package of FIG. 14; and

FIG. 21 depicts a food item cooked in the exemplary package of FIG. 18.

### DETAILED DESCRIPTION

The present invention generally relates to a package for cooking food item in a microwave oven. The food item may be provided to the consumer pre-inserted into the package, or may be provided separately from the package. The package includes a susceptor that provides effective heating and/or browning of the food item, a thermal insulating material (also referred to herein as “insulating material”) that provides a surface for safe and comfortable handling by a consumer, and an optional support for the susceptor. In some aspects of the present invention, the insulating material may serve as the support for the susceptor. The package additionally includes features that enable the consumer to consume the food item “on the go”, without the need for transferring the food item to another utensil.

Susceptor

The susceptor of the present invention comprises a microwave energy interactive material deposited on or supported by a substrate. Depending on the microwave energy interactive material selected and its positioning in the packaging, the susceptor may absorb microwave energy, transmit microwave energy, or reflect microwave energy as desired for a particular food item. When the food item is placed inside the package, the microwave energy interactive material may be in proximate contact with the surface of the food item, intimate contact with the food item, or a combination thereof, as needed to achieve the desired cooking results.

The microwave energy interactive material may comprise an electroconductive or semiconductive material. According to one aspect of the present invention, the microwave energy interactive material may comprise a metal or a metal alloy provided as a metal foil; a vacuum deposited metal or metal alloy; or a metallic ink, an organic ink, an inorganic ink, a metallic paste, an organic paste, an inorganic paste, or any combination thereof. Examples of metals and metal alloys that may be suitable for use with the present invention include, but are not limited to, aluminum, chromium, copper, inconel alloys (nickel-chromium-molybdenum alloy with niobium), iron, magnesium, nickel, stainless steel, tin, titanium, tungsten, and any combination thereof.

While metals are inexpensive and easy to obtain in both vacuum deposited or foil forms, metals may not be suitable for every application. For example, in high vacuum deposited thickness and in foil form, metals are opaque to visible light and may not be suitable for forming a clear microwave package or component. Further, the interactive properties of such vacuum deposited metals for heating often are limited to heating for narrow ranges of heat flux and temperature. Such materials therefore may not be optimal for heating, browning, and crisping all food items. Additionally, for field management uses, metal foils and vacuum deposited coatings can be difficult to handle and design into packages, and can lead to arcing at small defects in the structure.

Thus, according to another aspect of the present invention, the microwave interactive energy material may comprise a metal oxide. Examples of metal oxides that may be suitable for use with the present invention include, but are not limited to, oxides of aluminum, iron, and tin, used in conjunction with an electrically conductive material where needed. Another example of a metal oxide that may be suitable for use with the present invention is indium tin oxide (ITO). ITO can be used as a microwave energy interactive material to provide a heating effect, a shielding effect, or a combination thereof. To form the susceptor, ITO typically is sputtered onto a clear polymeric film. The sputtering process typically occurs at a lower temperature than the evaporative deposition process used for metal deposition. ITO has a more uniform crystal structure and, therefore, is clear at most coating thicknesses. Additionally, ITO can be used for either heating or field management effects. ITO also may have fewer defects than metals, thereby making thick coatings of ITO more suitable for field management than thick coatings of metals, such as aluminum. Alternatively, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

The substrate used in accordance with the present invention typically comprises an electrical insulator, for example, a polymeric film. The thickness of the film may typically be from about 40 to about 55 gauge. In one aspect, the thickness of the film is from about 43 to about 52 gauge. In another aspect, the thickness of the film is from about 45 to about 50 gauge. In still another aspect, the thickness of the film is about 48 gauge. Examples of polymeric films that may be suitable include, but are not limited to, polyolefins, polyesters, polyamides, polyimides, polysulfones, polyether ketones, cellophanes, or any combination thereof. Other non-conducting substrate materials such as paper and paper laminates, metal oxides, silicates, cellulosics, or any combination thereof, may also be used.

According to one aspect of the present invention, the polymeric film may comprise polyethylene terephthalate. Examples of polyethylene terephthalate film that may be suitable for use as the substrate include, but are not limited to, Melinex®, commercially available from DuPont Teijan Films (Hopewell, Va.), and SKYROL, commercially available from SKC, Inc. (Covington, Ga.). Polyethylene terephthalate films are used in commercially available susceptors, for example, the QWIK WAVE® Focus susceptor and the MICRO-RITE® susceptor, both available from Graphic Packaging International (Marietta, Ga.).

According to another aspect of the present invention, the polymeric film may be selected to provide a water barrier, oxygen barrier, or a combination thereof to the susceptor. This “barrier susceptor” may be used in combination with gas flushing using carbon dioxide or nitrogen to provide an extended shelf life product for refrigerated, shelf stable, or frozen foods. The barrier susceptor may be used to form a package that stores the product from the time of manufacture and shipping, through the cooking process, and during consumption. Any suitable film may be used to form a susceptor in accordance with the present invention including, but not limited to, ethylene vinyl alcohol, barrier nylon, polyvinylidene chloride, barrier fluoropolymer, nylon 6, nylon 66, silicon oxide coated film, or any combination thereof. Additional examples barrier materials that may be suitable are provided in U.S. patent application Ser. No. 10/954,435, incorporated by reference herein in its entirety.

The microwave energy interactive material may be applied to the substrate in any suitable manner, and in some instances, the microwave energy interactive material is printed on, extruded onto, sputtered onto, evaporated on, or laminated to the substrate. The microwave energy interactive material may be applied to the substrate in any pattern, and using any technique, to achieve the desired heating effect of the food item. For example, the microwave energy interactive material may be provided as a continuous or discontinuous layer or coating, circles, loops, hexagons, islands, squares, rectangles, octagons, and so forth. Examples of alternative patterns and methods that may be suitable for use with the present invention are provided in U.S. Pat. Nos. 6,765,182; 6,717,121; 6,677,563; 6,552,315; 6,455,827; 6,433,322; 6,414,290; 6,251,451; 6,204,492; 6,150,646; 6,114,679; 5,800,724; 5,759,422; 5,672,407; 5,628,921; 5,519,195; 5,424,517; 5,410,135; 5,354,973; 5,340,436; 5,266,386; 5,260,537; 5,221,419; 5,213,902; 5,117,078; 5,039,364; 4,963,424; 4,936,935; 4,865,921; 4,890,439; 4,775,771; and Re. 34,683; each of which is incorporated by reference herein in its entirety.

Although particular examples of the microwave energy interactive material are shown and described herein, it should be understood that other patterns of microwave energy interactive material are contemplated by the present invention.

According to yet another aspect of the present invention, the susceptor optionally is laminated to a support. The support may comprise a partial or complete layer of the susceptor. The support may be formed from paper, paperboard, a low shrink polymer, or any other suitable material. Thus, for example, a metallized polymer film may be laminated to a paper, for example, a kraft paper, or alternatively, a low shrink polymer film, for example, a cast nylon 6 or nylon 6,6 film, or a coextruded film containing such polymers. One such material that may be suitable for use with the present invention is DARTEK, commercially available from DuPont Canada. Where the support is paper, the support may have a basis weight of about 15 to about 30 lbs/ream. In one aspect, the paper support as a basis weight of about 20 to about 30 lbs/ream. In another aspect, the paper support has a basis weight of about 25 lbs/ream. Where the support is paperboard, the support may have a thickness of about 8 to about 20 mils. In one aspect, the paperboard support has a thickness of about 10 to about 18 mils. In another aspect, the paperboard support has a thickness of about 13 mils.

If desired, the support may be coated or laminated with other materials to impart other properties, such as absorbency, repellency, opacity, color, printability, stiffness, or cushioning. Absorbent susceptors are described in U.S. Provisional Patent Application No. 60/604,637, filed Aug. 25, 2004, and U.S. Patent Application Publication No. 2006/0049190, published Mar. 9, 2006, both of which are incorporated herein by reference in its entirety. Additionally, the support may include graphics or indicia printed thereon. Where no additional support is present, the insulating material may act as a support for the susceptor, may be in direct contact with the susceptor, and/or may be affixed thereto thermally, adhesively, mechanically, or any combination thereof, as is shown and described herein.

Insulating Material

The thermal insulating material of the present invention comprises any flexible, substantially flexible, substantially rigid, or rigid material that minimizes the heat flux from the hot food item to the exterior of the package. As a result, the insulating material protects the consumer from contact with the heat generated during the cooking process. Typically, the insulating material provides a surface that is “cool to the touch”, referring to a surface temperature of less than from about 130° F. to about 140° F.

Various insulating materials are contemplated by the present invention including, but not limited to, extruded polymers, injection molded polymers, thermoformed polymers, polymeric foams, bubble material, paperboard, paperboard laminates, cardboard, laminated molded pulp, single side fluted board, double side fluted board, corrugated board, or any combination thereof. If desired, the insulating material may be coated or laminated with other materials to impart various properties, such as absorbency, repellency, opacity, color, printability, stiffness, or cushioning. Additionally, the insulating material may include graphics or indicia printed thereon.

The insulating material typically is positioned exterior to the susceptor, and distal from the food item. The insulating material may be the outermost layer of the packaging and may be in direct contact with the hand of the user. Alternatively, the insulating material may not be the outermost layer of the packaging and may not be in direct contact with the hand of the user. Alternatively still, the insulating material may not be the outermost layer of the packaging and may be in direct contact with the hand of the user. For example, where the insulating material serves as the support for the susceptor, all or a portion of the insulating material may be in direct contact with the food item, and all or a portion of the insulating material may be in direct contact with the hand of the user.

Additionally, the insulating material may be provided as various shapes and configurations. For example, the insulating material may form a shell into which all or a portion of the susceptor is placed. Alternatively, the insulating material may form a sleeve into which all or a portion of the susceptor is placed. Alternatively, still, the insulating material may be applied to an otherwise supported susceptor to provide one or more insulated regions in the package into which the susceptor material is placed.

Furthermore, the insulating material may be provided as a separate construct from the susceptor. For example, the insulating material may be provided as a pouch into which a susceptor material is inserted by the user. The insulating material may alternatively be provided as unitary construct in which the components are joined together by adhesive bonding, thermal bonding, mechanical bonding, mechanical fastening, or by any other method technique, or by any combination thereof, prior to use by the consumer.

According to one aspect of the present invention, the overall dimensions of the insulating material are substantially equal to the overall dimensions of the susceptor so that the entire surface of the susceptor is enclosed by the insulating material. According to another aspect of the present invention, the overall dimensions of the insulating material are less than the overall dimensions of the susceptor, so that the insulating material covers only a portion or portions of the susceptor. In some instances, the insulating material may be positioned to correspond to the locations that a user typically would contact when handling the packaged food item. Thus, for example, the insulating material may be present to cover the bottom edge and some lower portion of the susceptor. Further, if desired, the insulating material may serve as the support for the susceptor, as is shown and described herein.

It should be understood that while various exemplary arrangements and configurations are provided herein, numerous other arrangements and configurations are contemplated by the present invention.

Bubble Material

According to one aspect of the present invention, the insulating material comprises a flexible bubble packing material, for example, BUBBLE WRAP®, commercially available from Sealed Air Corporation (Saddle Brook, N.J.). Various other flexible bubble packing materials are commercially available, and their use is contemplated hereby.

Bubble materials typically comprise two layers of flexible film. Bubbles are thermally formed in a first layer, which is then attached to a flat second layer. Optionally, the second layer also may be formed to include bubbles. In such instances, the bubbles in the first layer and the bubbles in the second layer may be formed in any pattern or configuration, for example staggered or registered, facing toward each other or facing away from each other. However, it should be understood that other bubble materials are contemplated by the present invention, including bubble materials having multiple layers with multiple configurations, and laminates and alternate constructions thereof.

Typically, a non-raised area is present between the bubbles. According to one aspect of the present invention, the flat surface of the bubble material is positioned in the package proximal to the susceptor. According to another aspect of the present invention, the flat surface of the bubble material is positioned in the package distal from the susceptor.

If desired, the bubble may be formed in a single ply of flexible film, which then may be adhered to the exterior surface of the susceptor or optional support.

Additionally, according to another aspect of the present invention, the susceptor may be formed by laminating a metallized polymer film directly to a flexible film or by extrusion coating the metallized surface with a polymer film. This highly flexible susceptor then may be used in combination with the bubble material concepts described herein, thereby obviating the need for a separate support such as paper for the susceptor. Further still, a transparent package may be constructed according to this aspect of the present invention by using ITO as the microwave energy interactive material.

According to one aspect of the present invention, the overall dimensions of the insulating bubble material are substantially equal to the overall dimensions of the susceptor, so that the bubble material substantially surrounds the susceptor. In this aspect, the bubble material may have a single open end that corresponds to the open end of the susceptor. Alternatively, the bubble material may have two open ends, one that corresponds to the open end of the susceptor, and one that corresponds to the closed end of the susceptor distal from the open end of the susceptor. Still further, it is contemplated that a bubble material having two open ends may be slidably adjusted to position the insulating material in the location that the consumer grips the package. In this and other aspects of the present invention, the bubble material may be affixed to the susceptor or the optional support if desired. Any suitable method of affixing the bubble material to the other components may be used, for example, thermal bonding, adhesive bonding, mechanical bonding, or any combination thereof.

According to another aspect of the present invention, the overall dimensions of the bubble material are less than the overall dimensions of the susceptor, so that the bubble material covers only a portion or portions of the susceptor. For example, the bubble material may be positioned on the food item package to provide discrete insulated areas to grip the package when the food item contained therein is hot.

If desired, the pattern of bubbles may be modified as needed for a particular food item. Such a modification might be made, for example, where it is desirable to provide some bubbles and the one or two layers of film typically used to form the bubble material, but it is not necessary or desirable to have a continuous pattern of bubbles.

Furthermore, the height of the bubbles may be modified as desired for each food item. A greater volume of air within the bubble generally corresponds to greater insulation of the food item. Thus, for a food item that does not require as much heat to be prepared, for example, certain sandwich products, it might not be necessary to have a thick insulating layer. In contrast, for a food item that requires more heat to be prepared, for example, a fruit pie, it might be necessary or desirable to have a thicker insulating layer. In one aspect, the thickness of the bubble material is about 1/16 in., ⅛ in., 3/16 in., ¼ in., 5/16 in., ⅜ in., ½ in., or any thickness therebetween.

The present invention also contemplates using a range of bubble heights and sizes in the bubble material, so that each package has selectively varying bubble dimensions. This might be desirable where, for example, the product has an irregular shape and the product will not fit readily into the product box with other wrapped food items. This might also be desirable where, for example, the intended use for the food item is an “on the go meal” and it is desirable to have a package that conforms to a cup holder in an automobile. In some such instances, it might be necessary or desirable to use a larger bubble size on the bottom portion of the package to stabilize the package when it is in an upright position. In contrast, depending on the size of the product, it might be necessary or desirable to have a package having a smaller bubble size on the bottom portion of the package to enable the package to fit within a cup holder of an automobile. Thus, it should be understood that numerous combinations of bubble heights and sizes are contemplated by the present invention for the purpose of achieving different package attributes.

If desired, the flexible bubble material may be perforated or apertured in the non-raised or flattened areas to permit moisture to vent away from the food during microwave heating, thereby enhancing the browning and crisping of the food. According to one aspect of the present invention, the bubble material includes perforations or apertures that substantially correspond in location and size to perforations or apertures in the susceptor. According to another aspect of the present invention, the bubble material includes perforations or apertures that may or may not correspond to perforations or apertures in the susceptor. According to yet another aspect, the bubble material includes perforations or apertures, and the susceptor does not.

The flexible bubble wrap may be produced from any flexible, thermoformable polymer including, but not limited to, ethylene vinyl alcohol copolymer, polyethylene, polypropylene, nylon, or polyester, or any blend or copolymer thereof, or any laminated or coextruded multilayer structure thereof. According to one aspect of the present invention, the bubble material comprises a coextruded barrier film. When used in connection with gas flushing using carbon dioxide or nitrogen gas, the package may provide an extended shelf life for refrigerated, shelf stable, or frozen foods.

If desired, the bubble material may be formed at the point of food manufacture to eliminate the costs associated with shipping the large volume of air that would otherwise be contained in the bubbles. The method of forming the bubble material at the point of manufacturing comprises providing flexible film roll stock to a machine with inline thermoforming and packaging capabilities, thermoforming the film into the desired bubble configuration, and bonding the thermoformed film to, for example, a flat film, a susceptor support, or a susceptor. The method also contemplates additional processing steps including, for example, placing the food inside the package, drawing a vacuum on the package, flushing the package, heat sealing the package, and discharging the package. Food packaging machines of this nature may be provided by, for example, Multivac Inc. (Kansas City, Mo.).

Paperboard

According to another aspect of the present invention, the insulating material comprises paperboard, which may be provided as a “shell”. The shell may be formed from any suitable semi-rigid or rigid paperboard that is capable of supporting the susceptor and a food item contained therein. Typically, the paperboard may have a thickness of about 8 to about 20 mils. In one aspect, the paperboard support has a thickness of about 10 to about 18 mils. In another aspect, the paperboard support has a thickness of about 13 mils. The paperboard shell may receive a portion of the susceptor, or may receive substantially the entire susceptor. The paperboard shell may be adapted to accommodate different shaped food items using folds, gussets, pleats, and so forth. If sufficiently rigid, the paperboard shell may be used to form a shell that enables the food item to stand upright on a surface for easy handling. The paperboard shell may be coated or laminated with other materials to impart other properties, such as absorbency, repellency, opacity, color, printability, stiffness, cushioning, or surface texture. Further, the paperboard may be bleached. Additionally, the paperboard shell may include graphics or indicia printed thereon.

Corrugated Paperboard or Cardboard

According to another aspect of the present invention, the insulating material comprises a corrugated paperboard or cardboard (collectively “corrugated materials”). Corrugated materials may be used to form a partial or complete shell or sheath for the susceptor, may be used as a support for the susceptor, may be applied to a portion or portions of an otherwise supported susceptor, or any combination thereof.

As stated above, corrugated materials may be used in accordance with the present invention in a variety of manners. According to one aspect, a corrugated material is used as the support for a susceptor. In this aspect, the corrugated material has overall dimensions that are substantially equal to that of the susceptor. The food item to be heated is inserted into the package, or sleeve, for heating.

According to another aspect of the present invention, a corrugated material sheath partially receives the susceptor, which is supported by, for example, paper or flexible paperboard. In this aspect, the sheath has a first open end for receiving the susceptor and, optionally, a second open end distal from the open end of the susceptor.

According to yet another aspect of the present invention, a corrugated material is applied to a supported susceptor to protect the consumer from heat generated during the cooking process. In this aspect, the corrugated material may be applied in any pattern including, but not limited to, a stripe, square, circle, rectangle, or any other shape, or any plurality or combination thereof.

Some corrugated materials comprise a flat side and a corrugated side. Such materials often are referred to as “single faced”. Single faced corrugated materials that may be suitable for use with the present invention include, but are not limited to, flute sizes A, B (47 flutes/linear ft), and E (90 flutes/linear ft). Other corrugated materials comprise a first flat side, a second flat side, and corrugated material therebetween. Such materials often are referred to as “double faced”. Double faced corrugated materials that may be suitable for use with the present invention include, but are not limited to, flute sizes B, C, E, and F. The present invention contemplates any configuration of these materials in the package. Thus, according to one aspect of the present invention, a flat side of a corrugated material is disposed in a direction towards the susceptor. According to another aspect of the present invention, a corrugated side of a corrugated material is disposed in a direction towards the susceptor.

Corrugated paperboard and cardboard materials have a longitudinal direction that runs along the length of the flutes, and a transverse direction that runs across the flutes. Corrugated materials may be relatively stiff when the material is flexed in the longitudinal direction, and relatively flexible when flexed in the transverse direction. As such, some packages using corrugated materials may use fold lines, perforations, gussets, or other structural features to enable a product to be inserted into the package.

The corrugated material or cardboard may be coated or laminated with other materials to impart other properties, such as absorbency, repellency, opacity, color, printability, stiffness, cushioning, or surface texture. Further, the material may be bleached. Additionally, the material may include graphics or indicia printed thereon.

Foams

According to another aspect of the present invention, the insulating material comprises a flexible or semi-rigid, open or closed cell foam. In one aspect, the thickness of the foam is about 1/16 in., ⅛ in., 3/16 in., ¼ in., 5/16 in., ⅜ in., ½ in., or any thickness therebetween. The foam may be formed from any natural or synthetic material, for example, a polymeric material. The foam may be applied as a spray, a pre-formed material, or may be formed during the microwave cooking process. The foam may be used to form a partial or complete shell or sheath for the susceptor, may be used as a support for the susceptor, may be applied to a portion or portions of an otherwise supported susceptor, or any combination thereof.

As stated above, foams may be used in accordance with the present invention in a variety of manners. According to one aspect of the present invention, a foam sheath partially receives the susceptor material, which is supported by, for example, paper or flexible paperboard. In this aspect, the sheath has a first open end for receiving the susceptor, and optionally, a second open end distal from the open end of the susceptor.

According to another aspect of the present invention, a foam is used as the support for a susceptor. In this aspect, the foam has overall dimensions that are substantially equal to that of the susceptor.

According to yet another aspect of the present invention, a foam may be applied to an otherwise supported susceptor to protect the consumer from the heat generated during the cooking process. In this aspect, the foam may be applied in any pattern including, but not limited to, a stripe, square, circle, rectangle, any other shape, or any plurality or combination thereof.

According to another aspect of the present invention, an insulating foam is formed in situ by applying microwave energy to the package. In this aspect, the release of water from the food item or a paper layer may be used to initiate a chemical reaction or physical change in a polymer layer that results in the production of a polymer foam on or within the package. The polymer layer may form the exterior of the package, so that the resulting foam is in contact with the hand of the user. Alternatively, the polymer layer may be disposed between other layers, so that the change in construction is more subtle to the user.

Examples of polymers that may be used to form a foam layer in situ include, but are not limited to, low density, medium density, and high density polyethylene; polypropylene; polyvinyl chloride; polystyrene; polyester; nylon; or any combination thereof. A method for creating a foam layer from such polymers is provided in U.S. Pat. No. 4,435,344, incorporated by reference herein in its entirety.

There are numerous advantages to producing the insulating material in this manner. For example, the packaging constructs are reduced in size, thereby decreasing packaging size and weight, and therefore shipping and transportation costs. Additionally, consumers who might otherwise find a packaging construct to be excessive might be less likely to do so when the insulating material is formed in this manner.

Adhesives

According to another aspect of the present invention, the thermal insulting material comprises an adhesive. Any adhesive may be used, provided that the melting point of the adhesive is above the temperature to which it will be exposed before, during, and after the cooking process. The adhesive typically is applied to the exterior of the package to form one or more areas for gripping the package. Thus, the adhesive may be applied as one or more stripes, circles, rectangles, squares, diamonds, wavy lines, squiggles, or any combination thereof, or any other shape or pattern as desired. The adhesive may be applied using any suitable technique, such as slot coating, spray coating, roll coating, extrusion, or any combination thereof.

Polymers

According to still another aspect of the present invention, the thermal insulating material comprises a polymer, or combination of polymers. Any polymer may be used, provided that the melting point of the polymer is above the temperature to which it will be exposed before, during, and after the cooking process. Examples of polymers that may be suitable for use with the present invention include, but are not limited to, polypropylene, polyethylene, nylon, and polyethylene terephthalate.

In one aspect, the polymer is applied to the exterior of the package, for example, a sleeve. The polymer may be positioned on the exterior of the package to provide discrete insulated areas to grip the package when the food item contained therein is hot.

The polymer may be applied as one or more stripes, circles, rectangles, squares, diamonds, wavy lines, squiggles, or any combination thereof, or any other shape or pattern as desired. It is contemplated that various patterns and designs may be used to provide aesthetic benefits in addition to the functional insulating benefits. Thus, for instance, a polymer may be applied in a colored or textured pattern, to indicate how to handle the product (e.g., an arrow to indicate how to handle the product or to indicate which end is up), what the product is (e.g., a sandwich design on a sleeve for a microwave sandwich product, an apple design for a microwaveable apple pie product, and so forth), or to provide some aesthetically pleasing visual image (e.g., the sun, flowers, smiley faces, cars, sailboats, and so forth).

In another aspect, the insulating polymer is applied between layers of material that form the sleeve, shell, or other packaging construct. For example, the polymer may be applied in stripes, circles, or otherwise as described above between two layers of film, between a layer of film and paper, between a layer of film or paper and the susceptor, or in any other manner as desired.

In still another aspect of the present invention, the insulating polymer may be applied both to the exterior of the package and between various materials used to construct the package. In this and other aspects, the polymer may be applied to the package or to any of the various components thereof using any suitable technique, such as slot coating, spray coating, roll coating, extrusion, or any combination thereof.

Exemplary Package Constructs

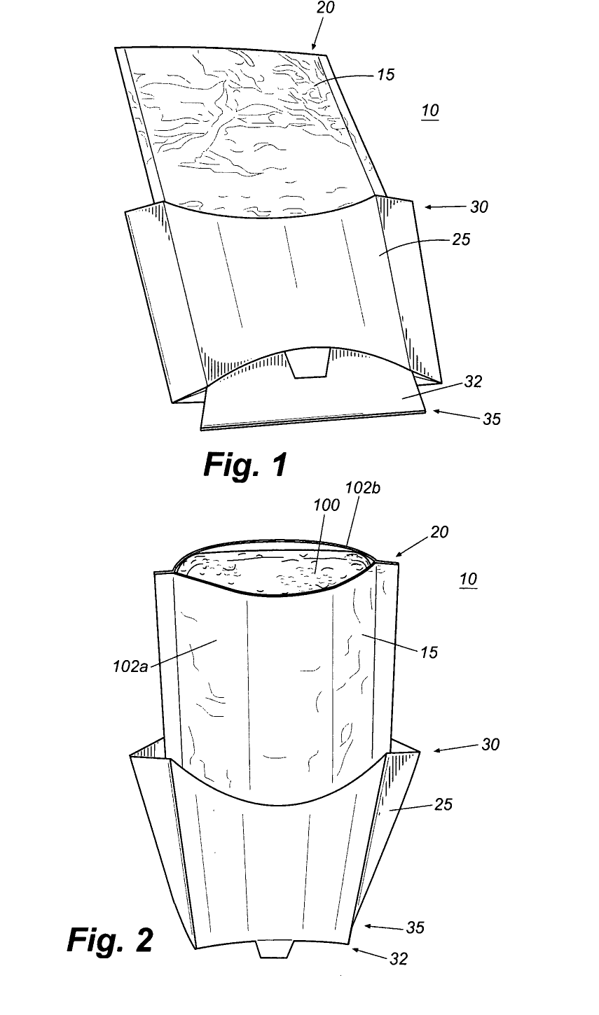

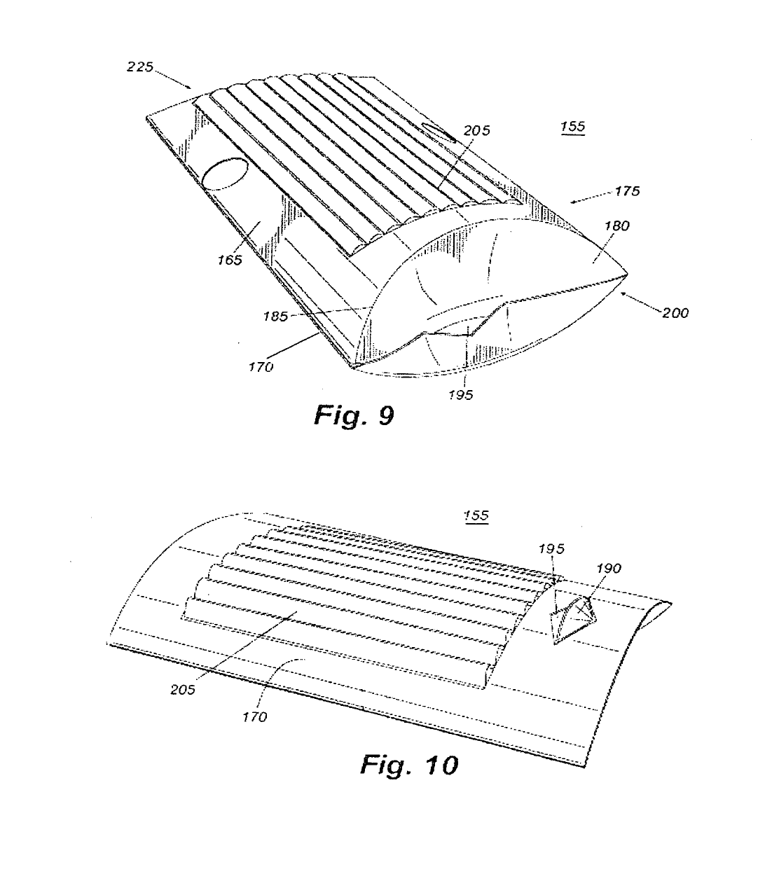

Various package constructs are contemplated by the present invention. FIGS. 1-20 depict several exemplary constructs that may be formed according to the present invention. The exemplary constructs have a “sleeve” or “pocket” or “pouch” configuration and are shown to be a hand-held package. However, it should be understood that other shapes and configurations are contemplated by the present invention. Examples of other shapes encompassed hereby include, but are not limited to, polygons, circles, ovals, cylinders, prisms, spheres, polyhedrons, and ellipsoids. The shape of the package may be determined largely by the shape of the food item, and it should be understood that different packages are contemplated for different food items, for example, sandwiches, pizzas, French fries, soft pretzels, pizza bites, cheese sticks, pastries, doughs, and so forth. Additionally, it should be understood that the present invention contemplates packages for single-serving portions and for multiple-serving portions, and is not restricted to hand-held packages. It also should be understood that various components used to form the packages of the present invention may be interchanged. Thus, while only certain combinations are illustrated herein, numerous other combinations and configurations are contemplated hereby.

Turning to FIGS. 1 and 2, a package 10 for a microwaveable food item 100 is provided. The package 10 includes a susceptor in the form of a sleeve 15 in which the food item 100 is placed for cooking. The sleeve 15 includes an open end 20 for receiving the food item 100.

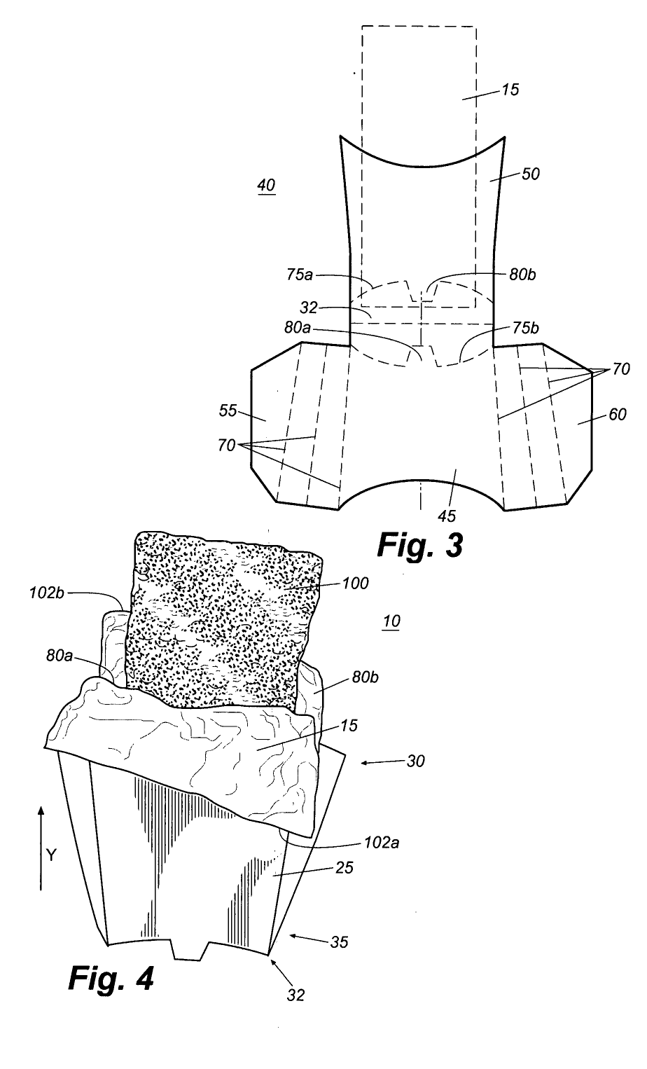

The package 10 further includes an insulating shell 25 that receives at least a portion of a susceptor sleeve 15. The shell 25 provides a stable device for supporting the food item in an upright position (best seen in FIGS. 3 and 4). The shell 25 may be provided with a self-supporting base 32 for placing the food item on a surface, in the cup holder of a vehicle, and so forth, without causing the food item to tip over. The shell 25 may be formed from any suitable rigid or semi-rigid material, and in some instances, the shell 25 may be formed from paperboard.

The shell 25 includes an open end 30 and a closed end 35. The closed end 35 may be formed by adhesive bonding, thermal bonding, mechanical bonding, any combination thereof, or by any other suitable mechanical folding or locking mechanism. The open end 30 of the shell 25 may have any suitable shape, and in some instances, the open end 30 has an arcuate shape. The arcuate shape permits the sides of the food item 100 to be supported, while exposing more food item 100 for access by the consumer.

An exemplary construction of the shell 25 and susceptor sleeve 15 of FIGS. 1 and 2 is provided in FIG. 3. A paperboard blank 40 comprises a front panel 45, a back panel 50 having the susceptor sleeve 15 attached thereto, a first side panel 55, a second side panel 60, and a bottom panel or base 32. The first side panel 55 and the second side panel 60 are perforated or scored at lines 70 to enable folding. The bottom panel 40 includes arcuate perforations or fold lines 75a and 75b and tabs 80a and 80b. To assemble the package 10, the back panel 50 is brought toward the front panel 45 and folded at fold lines 75. The first side panel 55 and the second side panel 60 are brought together to form an overlap and joined using adhesive. The tabs 80 provide feet for the shell 25 to stand on when the package 10 is placed on a surface.

The food item inserted into the sleeve may be heated in a microwave oven until the product reaches the desired temperature. In some instances, the temperature of the surface of food item may be as high as 400° F. However, the presence of the thermal insulating shell enables the user to remove the item from the microwave oven without potential for burns or discomfort.

Turning to FIG. 4, to consume the food item 100, the user can peel the layers or panels 102a, 102b of the susceptor sleeve 15 apart at seams 80a, 80b and pull the layers towards the shell 25. The consumer can confidently handle the food item 100 without concern about portions of the food item leaking from the base 32 of the shell 25. Upon reaching the shell 25, the consumer can apply a gentle pressure to the bottom of the food item 100 disposed within the sleeve 15 inside the shell 25, thereby causing the food item 100 to move upward in a direction Y toward the open end 30 of the shell 25. Alternatively, if the food item 100 has sufficiently cooled, the user optionally may remove the remainder of the product 100 from the package and consume it.

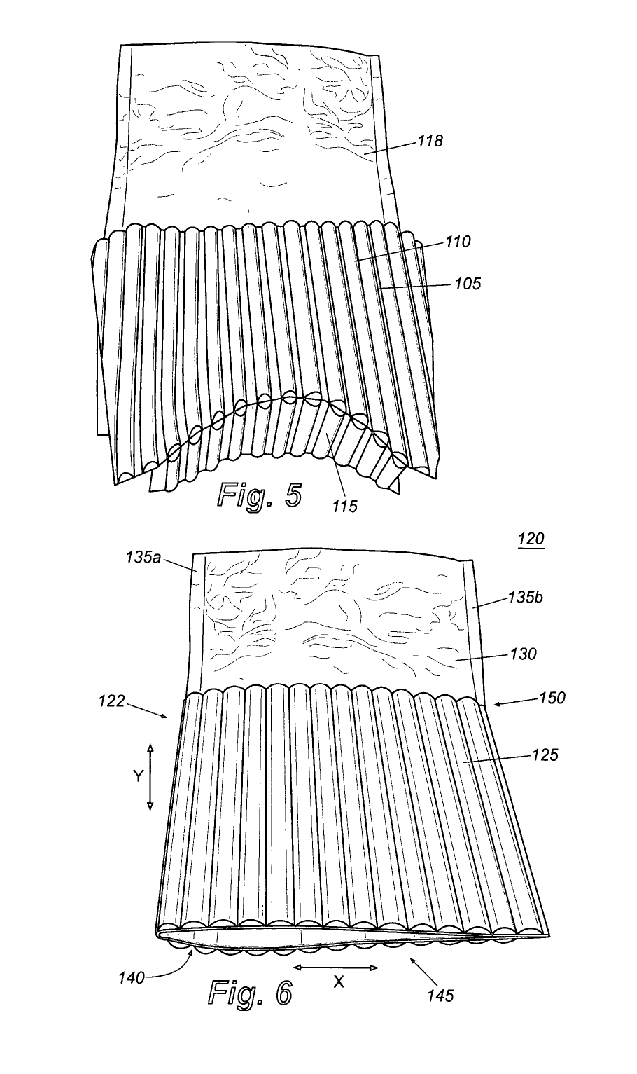

According to another aspect of the present invention depicted in FIG. 5, the shell 105 is formed from a corrugated material. The shell 105 may include an arcuate front panel 110 and/or an arcuate back panel (not shown). Additionally, the base 115 may be arcuate in shape and may include tabs or feet (not shown) for supporting the shell 105 when the food item/package is placed on a surface. In this exemplary construction, the corrugated side of the paperboard is facing outward from the sleeve 118 in a direction away from the susceptor. It should be understood that the corrugated side may alternatively face inward in a direction toward the susceptor if desired.

According to another aspect of the present invention depicted in FIG. 6, a package 120 comprising a susceptor sleeve 130 and a sheath 125 is provided. The susceptor sleeve 130 may be formed as above, with sealed side edges 135a and 135b and a sealed bottom edge 140 (not shown). The flexible sheath 130 is formed from a material having a longitudinal direction Y and a transverse direction X, for example, a corrugated material. The corrugated material is folded over from a side 122 and affixed adhesively or otherwise to the surface of the sleeve 130 to form the sheath 125. The sheath 125 is flexible in the transverse direction X, but semi-rigid to rigid in the transverse direction Y. The sheath 125 features an open bottom end 145 in addition to an open top end 150. The sheath 125 thus “opens up” to receive the food item (not shown) within the sleeve 130. The food item (not shown) can be inserted readily into the sleeve 130 without damaging the packaging or the food item (not shown).

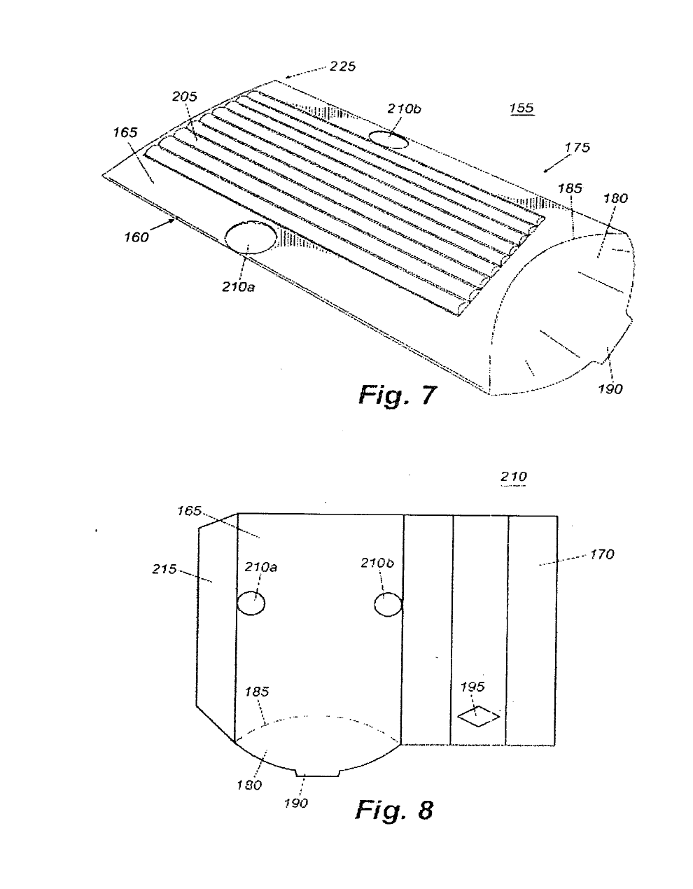

Turning to FIGS. 7-10, another package 155 formed according to the present invention is provided. The susceptor shell 160 is formed from a semi-rigid or flexible paperboard having the microwave energy interactive material supported thereon (not shown). The microwave energy interactive material may be applied in any pattern as desired, and in some instances, may be substantially continuous.

The shell 160 includes a front panel 165 and a back panel 170. The front panel 165 is generally rectangular in shape, and has one end 175 having an amygdaloidal (almond-shaped) flap 180 extending therefrom. The flap 180 is formed at a perforation or fold line 185 in the front panel 165. At a portion of the flap 180 distal from the perforation or fold line 185, the flap 180 may include a tab 190. The back panel 170 may include a slot 195 for receiving the tab 190 to form a bottom panel 200. The slot 195 may have any suitable shape (depending on the shape of the tab 190), and in some instances, the slot 195 may be diamond-shaped. Upon insertion of the tab 190 into the slot 195, the bottom panel 200 remains locked during use and fully supports the food item contained therein when the package 155 is held in a generally upright position.

An exemplary blank 210 for forming the package 155 is provided in FIG. 8. To assemble the package 155, the back panel 170 is brought towards a side flap 215 so that the susceptor is on the interior of the package 155. The side flap 215 is tucked under the back panel 170 and adhered thereto using an adhesive or other suitable method. Flap 180 is then folded towards the back panel 170, and tab 190 is inserted into slot 195. The package 155 remains in a locked position at this closed end 200 and open at an open end 225 for receiving the food item (not shown).

At least a portion of the interior of the front panel 165 or the back panel 175, or both, includes an insulating material 205 applied thereto. The insulating material may be a corrugated paper as shown, or may be any other material described herein or contemplated hereby. The insulating material 205 typically may be applied in places on the front panel 165, back panel 170 (not shown), or both, where a user would hold the package 155 to consume the food item (not shown). The insulating material 205 may be applied as a continuous insulating region or as one or more several separate insulating regions, and may extend around the susceptor, from the top to the bottom of the susceptor if desired. According to one aspect of the present invention, an insulating material 205 is applied to a portion of the exterior of the front panel 165 and to a portion of the exterior of the back panel 170 (not shown). Thus, a package is provided that protects the user from the heat generated during the cooking process, contains the food item without leaking, and is conveniently transported from the microwave to the user's destination.

Additionally, one or more apertures 210a and 210b may be provided to assist with venting of the package 155 during cooking. Circular apertures are shown; however, it should be understood that any shaped aperture may be used as desired. The use of apertures to enhance the results of microwave cooking are described in U.S. Pat. No. 4,948,932, incorporated by reference herein it its entirety.

According to another aspect of the present invention not shown, the package may have a front panel comprising a first end flap and a second end flap, each of which is adapted to be inserted into a first slot and a second slot in the back panel. Thus, according to this aspect, either or both ends may be sealed during the cooking process and/or for handling of the food item. Thus, a consumer who, for example, cooks a food item in a microwave oven, is able to transport the food item from one location to another, e.g., home to work, work to home, etc., without concern about the food item dislodging from the package.

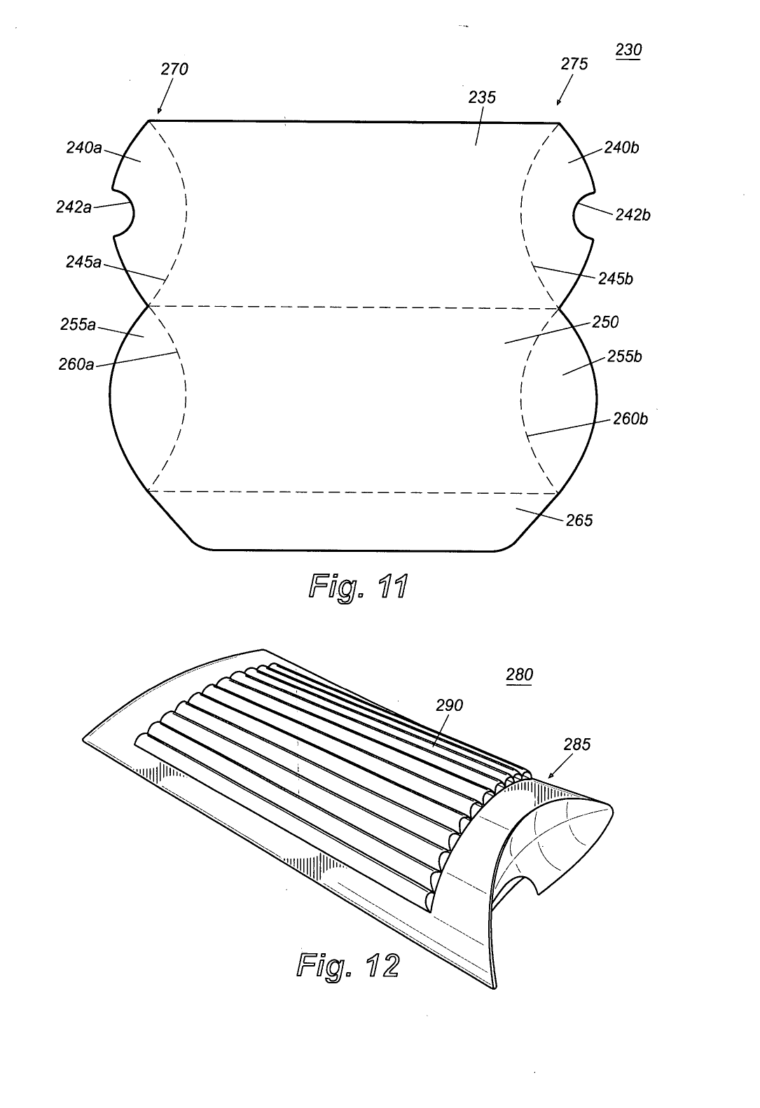

FIG. 11 depicts an alternative construction of a package blank 230 that forms a package capable of closing at each end. The package blank 230 comprises a front panel 235 including a first end flap 240a and a second end flap 240b, each of which includes an arcuate cutout 242a and 242b, respectively, and is adapted to be folded toward the interior of the package at arcuate perforations or fold lines 245a and 245b. The package blank 230 also includes a back panel 250 including a third end flap 255a and a fourth end flap 255b, each of which is adapted to be folded towards the interior of the package at arcuate perforations or fold lines 260a and 260b. To assemble the package blank 230 into a package (not shown), the front panel 235 is folded in a direction towards a side panel 265 that results in the susceptor being on the interior of the package. The side flap 265 is tucked under the front panel 235 and adhered thereto using an adhesive or any other suitable method. End flaps 240a and 255a are folded toward one another, thereby closing a first end 270. End flaps 240b and 255b are folded toward one another, thereby closing a second end 275.

By way of example and not by limitation, FIG. 12 depicts an exemplary package 280 having the double flap construction described in connection with FIG. 11 at one end 285 of the package 280. The package further includes an insulating material 290, in this instance, a corrugated material. An insulating material 290 also may be present on the back panel (not shown). Furthermore, while the package depicted in FIG. 12 includes an insulating material having the corrugations facing in a direction away from the susceptor, alternative constructions in which the corrugations are facing in a direction toward the susceptor are also contemplated hereby.

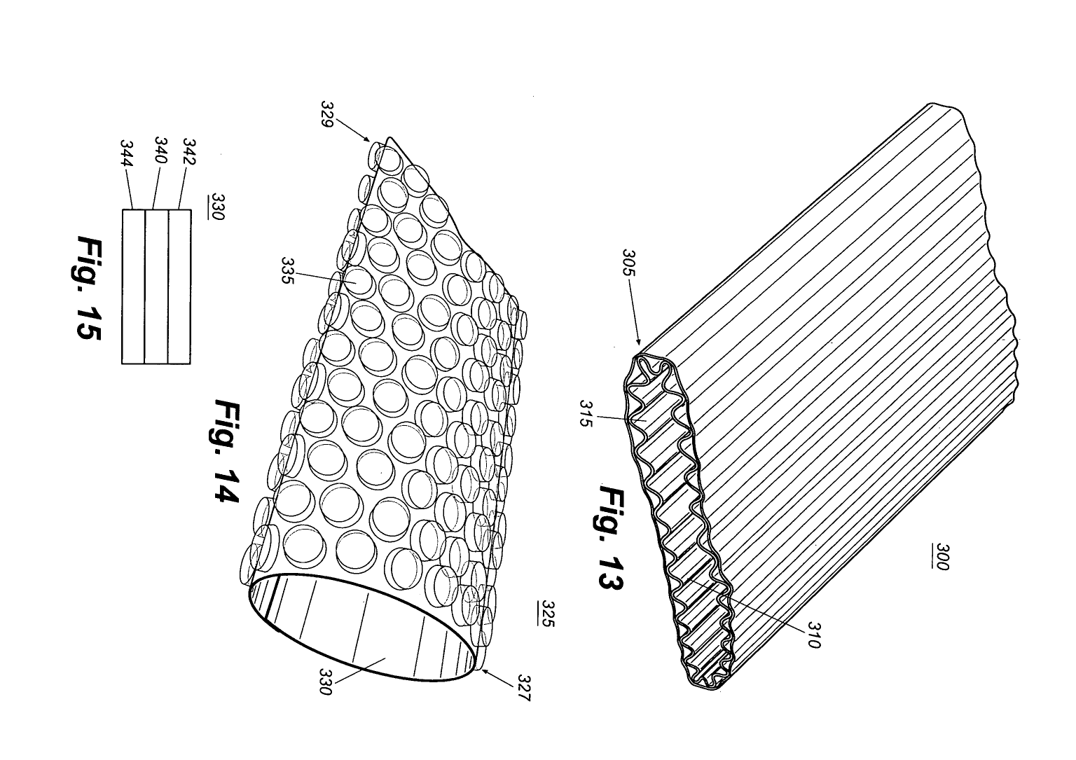

According to another aspect of the present invention depicted in two views in FIG. 13, a package 300 formed from a corrugated material is provided. The package 300 includes an open end 305 for inserting the food item (not shown) therein. The susceptor 310 is on the corrugated side of the corrugated material, such that the flutes of the corrugated material comprise the susceptor. Thus, some of the susceptor 310 is in intimate contact with the food item (not shown), and some of the susceptor 310 is in proximate contact with the food item (not shown). The flutes 315 on the interior of the package 300 provide the desired insulating effect to enable the consumer to handle the package comfortably, and also channel moisture generated during the cooking cycle to the open end 305 of the package 300. Thus, this construction additionally improves the browning and crisping of the food item.

An alternate construction of a package 325 of the present invention is provided in FIG. 14. The package 325 includes an open end 327 and a closed end 329. According to this aspect, a susceptor 330 is laminated to a bubble material 335. The susceptor comprises a metal 340 deposited on a polyester film 342 and laminated to a paper 344, as provided in FIG. 15. However, it should be understood that the susceptor alternatively may include a metal or a metal alloy provided as a metal foil; a vacuum deposited metal or metal alloy; or a metallic ink, an organic ink, an inorganic ink, a metallic paste, an organic paste, an inorganic paste, or any combination thereof. The bubble material 335 may be positioned in a direction towards or away from the susceptor 330. In the example depicted in FIG. 14, the bubble material 345 is positioned in a direction away from the susceptor 330. Additionally, the bubble material 335 substantially covers the susceptor 330. However, it should be understood that the bubble material 345 may be applied to any portion of the susceptor 330 as needed to support the food item (not shown) contained therein, and to provide sufficient insulation to protect the consumer from the hot product.

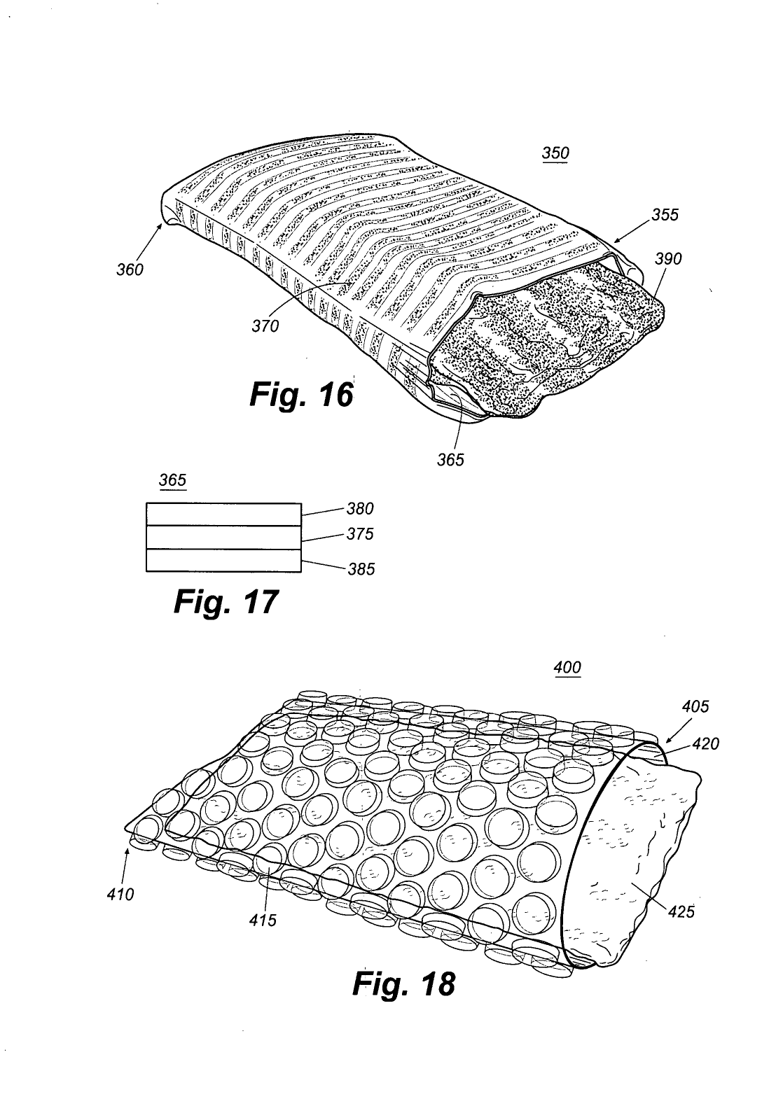

According to another aspect of the present invention depicted in FIG. 16, a package 350 for microwave cooking comprises an open end 355 and a closed end 360. The package 350 comprises a susceptor 365 laminated to an foam insulating material 370. In this exemplary construction, the insulating material 370 is a closed cell foam; however, open cell foams and other insulating materials described herein or contemplated hereby may be used. The susceptor 365 is formed from a metal 375 deposited on a polyester film 380 and laminated to a paper 385, as shown in FIG. 17. However, it should be understood that the susceptor alternatively may include a metal or a metal alloy provided as a metal foil; a vacuum deposited metal or metal alloy; or a metallic ink, an organic ink, an inorganic ink, a metallic paste, an organic paste, an inorganic paste, or any combination thereof. In the exemplary configuration of FIG. 16, the foam 370 substantially covers the susceptor 365. However, it should be understood that the foam 370 may be applied to any portion of the susceptor 365 as needed to support the food item 390 contained therein, and to provide sufficient insulation to shield the consumer from the heat generated during the cooking process.

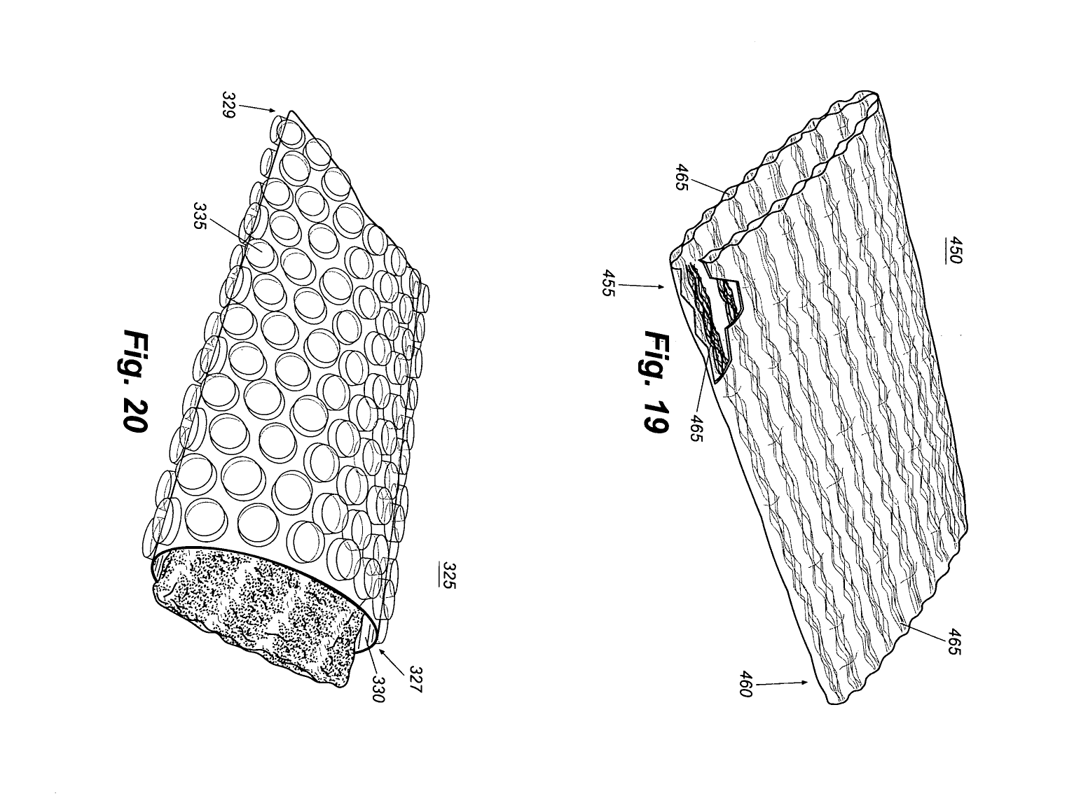

FIG. 18 depicts yet another aspect of the present invention. A package 400 includes an open end 405 and a closed end 410, and is formed from a bubble material 415 laminated to a metallized polyester film susceptor 420. In this example, the susceptor 420 does not include a paper layer. Thus, where vacuum deposited aluminum or other metals are used, the package is a translucent gray, in contrast to the more opaque packages typically formed using a paper support. In this exemplary configuration, the package 400 substantially covers the food item 425. However, it should be understood that the package 400 may be designed so that the bubble material 415 and susceptor 420 only partially cover the food item 425. In this and other aspects, the configuration of the package will depend on the size and shape of the food item contained therein, the desired degree of browning and crisping, and the amount of coverage needed to provide sufficient insulation to provide for comfortable handling and protect the consumer from the hot product.

FIG. 19 depicts still another aspect of the present invention. A package or sleeve 450 includes an open end 455 and a closed end 460, and is formed from a material comprising two layers of flexible nylon film having nylon insulating strips 465 laminated therebetween. The nylon film layers are laminated to a metallized PET film, such that the metallized side of the PET film is positioned in a direction away from the food item (not shown). In this aspect, the nylon strips act as the insulating material to protect the consumer from the heat generated during the cooking process. Those of ordinary skill in the art will understand that other arrangements of the various layers may be used in the present invention. For example, to achieve enhanced browning of the food item, the metallized layer could be positioned in a direction toward the food item.

### EXAMPLES

In each of the following examples, the efficacy of the package of the present invention was evaluated for (1) providing the desired heating and browning effect, and (2) providing the desired thermal insulation so that the product was cool to the touch upon removal from the microwave oven. In each example, a Nestlé HOT POCKET® with a precooked pastry outer shell and chicken & cheddar filling (4 oz.) was cooked for 2 minutes in a 1999 Panasonic 1100 watt model NNS540-BFW microwave oven (manufactured September 2001) with a turntable. The products were stored in a non-“frost free” freezer to avoid cycling temperatures. The temperature of the food item was monitored to assure a zero degree start point for product. Prior to each evaluation, the oven was pre-conditioned for 5 minutes with a 2000 gram water load. Also, the turntable was cooled to ambient temperature after each test to prevent accumulation of heat. The oven was periodically power tested via a standard water heating test to confirm performance. Additionally, the oven was on its own separate electrical circuit to control line voltage variation from test-to-test.

### Example 1

The package of FIGS. 1-3 was used to prepare a HOT POCKET® brand sandwich according to the procedure described above. FIG. 4 depicts the resulting food item. The package was cool to the touch upon removal of the food item from the oven. Additionally, the product was sufficiently heated, crisped, and browned.

### Example 2

The package of FIG. 14 was used to prepare a HOT POCKET® brand sandwich from according to the procedure described above. FIG. 20 depicts the resulting food item. The package was cool to the touch upon removal of the food item from the oven. Additionally, the product was sufficiently heated, crisped, and browned.

### Example 3

The package of FIG. 16 was used to prepare a HOT POCKET® brand sandwich according to the procedure described above. FIG. 16 depicts the resulting product. The package was cool to the touch upon removal of the food item from the oven. Additionally, the product was sufficiently heated, crisped, and browned.

### Example 4

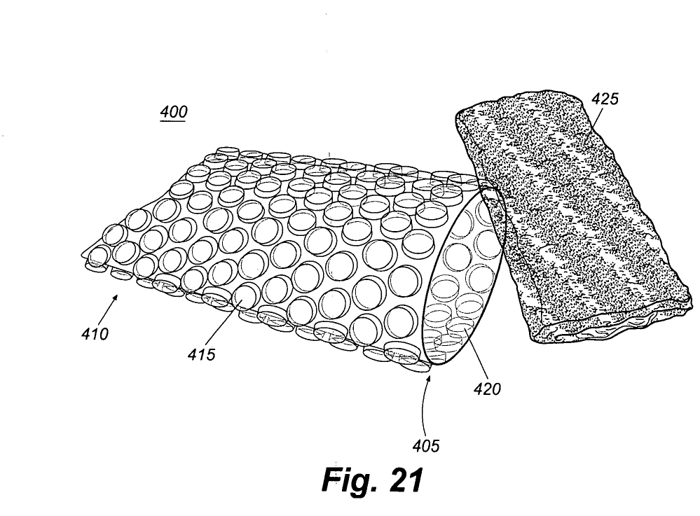

The package of FIG. 18 was used to prepare a HOT POCKET® brand sandwich according to the procedure described above. FIG. 21 depicts the resulting product. The package was cool to the touch upon removal of the food item from the oven. Additionally, the product was sufficiently heated, crisped, and browned.

In sum, the various packages encompassed by the present invention each include a susceptor, an insulating material, and an optional support. The packages of the present invention provide numerous advantages over currently available food item packages from the time of manufacture through storage, cooking, and consumption.

First, the present invention contemplates packages for use with single-serving products or multiple-serving products. Thus, the packages of the present invention are readily adaptable for use with a point of sale product. Additionally, the package configurations are compatible with high speed packaging equipment.

Further, by selecting the materials to have barrier properties, the packages of the present invention may be used with foods that are desired to have a longer shelf life.

Furthermore, the packages of the present invention provide superior heating, browning, and crisping. The packages are sufficiently flexible to provide intimate or proximate food contact, thereby permitting the susceptor to remain in intimate or proximate contact with irregular and inconsistent food shapes, including rising dough food formulations, for maximum heat flux from the susceptor to the food surface. Additionally, various packages of the present invention provide features that increase the contact between the susceptor and the food item, thereby increasing the rate of heat transfer to the food. Further, the packages of the present invention are vented to evacuate moisture, which in turn provides even browning and crisping over the entire food item. Additionally, the packages of the present invention are adapted readily to include susceptor technologies, such as the QWIK WAVE® Focus Susceptor or the MICRO-RITE® susceptor, that provide and enhance uniform product heating.

The packages of the present invention also offer greater convenience to the user. The packages feature an insulating material that provides a cool surface for handling immediately from the microwave oven. Additionally, the various packages of the present invention provide features that prevent the food from leaking from the bottom of the package when held in an upright position. Furthermore, depending on the materials selected, many of the components offer an oil and moisture absorbing feature to maintain the quality of the food item and prevent accidental drips onto clothing or skin. The packages are also portable and convenient to eat from.

Accordingly, it will be readily understood by those persons skilled in the art that, in view of the above detailed description of the invention, the present invention is susceptible of broad utility and application. Many methods, embodiments, and adaptations of the present invention other than those herein described, as well as many variations, modifications, and equivalent arrangements will be apparent from or reasonably suggested by the present invention and the above detailed description thereof, without departing from the substance or scope of the present invention. Accordingly, while the present invention is described herein in detail in relation to specific aspects, it is to be understood that this detailed description is only illustrative and exemplary of the present invention and is made merely for purposes of providing a full and enabling disclosure of the present invention. The detailed description set forth herein is not intended nor is to be construed to limit the present invention or otherwise to exclude any such other embodiments, adaptations, variations, modifications, and equivalent arrangements of the present invention, the present invention being limited solely by the claims appended hereto and the equivalents thereof.

What is claimed is:

1. A blank for forming a microwave heating package, comprising:
a plurality of adjoined panels having a first side and a second side opposite the first side, the plurality of panels including
a front panel,
a back panel foldably joined to the front panel along a first fold line,
an end panel joined to the front panel along an arcuate second fold line extending substantially between the first fold line and an edge of the front panel opposite the first fold line, the end panel including a tab extending from an arcuate edge of the end panel opposite the second fold line, and
a slot in the back panel adapted to receive the tab;
a microwave energy interactive material overlying at least a portion of the first side of the front panel and at least a portion of the first side of the back panel; and
a corrugated material overlying at least a portion of the second side of the front panel and at least a portion of the second side of the back panel.

2. The blank of claim 1, further comprising a side flap foldably joined to the front panel along the edge of the front panel opposite the first fold line.

3. The blank of claim 1, wherein
the first fold line extends in a direction, and
the blank further comprises a plurality of score lines in the back panel extending substantially in the direction of the first fold line.

4. The blank of claim 1, further comprising at least one aperture.

5. The blank of claim 1, wherein the microwave energy interactive material comprises a susceptor.

6. The blank of claim 1, wherein the microwave energy interactive material converts at least a portion of impinging microwave energy into thermal energy.

7. The blank of claim 1, wherein the microwave energy interactive material is selected from the group consisting of aluminum, indium tin oxide, and any combination thereof.

8. The blank of claim 1, wherein
the microwave energy interactive material is supported on a polymer film, and
the polymer film at least partially defines a surface of the blank.

9. The blank of claim 1, wherein the microwave energy interactive material is disposed between a layer of paper and a polymer film.

10. A package for heating, browning, and/or crisping a food item in a microwave oven, comprising:
a first panel and a second panel adjoined in an opposed, face-to-face relationship, the first panel and the second panel defining a cavity with a pair of opposed ends, wherein each of the first panel and the second panel includes an interior face comprising a microwave energy interactive material and an exterior face comprising a corrugated insulating material; and
an end panel foldably joined to the first panel along an arcuate fold line, the end panel including a tab extending outwardly from an arcuate edge opposite the arcuate fold line, wherein the tab is adapted to be received within a slot in the second panel.

11. The package of claim 10, wherein the pair of opposed ends includes a first open end and a second open end.

12. The package of claim 10, wherein the pair of opposed ends includes an open end and a closed end, wherein the closed end is formed by inserting the tab into the slot in the second panel.

13. The package of claim 12, wherein the closed end is adapted to serve as a base for the package in an upright position.

14. The package of claim 9, wherein the second panel includes a score line extending at least partially between the opposed ends of the package to facilitate insertion of the tab into the slot.

15. The package of claim 9, wherein the second panel includes a pair of substantially parallel score lines extending substantially between the opposed ends of the package to facilitate insertion of the tab into the slot.

16. The package of claim 10, further comprising at least one aperture in at least one of the first panel and the second panel.

17. The package of claim 10, wherein the microwave energy interactive material comprises a susceptor.

18. The package of claim 10, wherein the microwave energy interactive material is selected from the group consisting of aluminum, indium tin oxide, and any combination thereof.

19. The package of claim 10, wherein
the microwave energy interactive material is supported on a polymer film, and
the polymer film at least partially defines the interior face of the first panel and the second panel.

20. The package of claim 10, wherein
the microwave energy interactive material is disposed between a polymer film and a layer of paper, and
the polymer film at least partially defines the interior face of the first panel and the second panel.
